(19) United States
(12) Patent Application Publication
(10) Pub. No.: US 2005/0239473 A1
(43) Pub. Date: Oct. 27, 2005

(54) Radio access communications network, dynamic load distribution apparatus and dynamic load distribution method used in the same

(75) Inventors: Huanxu Pan, Tokyo (JP); Takashi Shiraki, Tokyo (JP)

Correspondence Address: YOUNG & THOMPSON, 745 SOUTH 23RD STREET, 2ND FLOOR, ARLINGTON, VA, 22202, US

(73) Assignee: NEC CORPORATION, TOKYO (JP)

(21) Appl. No.: 11/110,805

(22) Filed: Apr. 21, 2005

(30) Foreign Application Priority Data
Apr. 21, 2004 (JP) 2004-124900
Apr. 19, 2005 (JP) 2005-121324

(51) Int. Cl. H04Q 7/20

(52) U.S. Cl. 455/453; 455/450

(57) ABSTRACT

A dynamic load distribution apparatus in which resource allocation calculation for distributing load can be implemented by a simple and dynamically flexible algorism. An input apparatus receives from the network administrator the information on location of each base station apparatus or the information on base station apparatus. A load detection apparatus detects the traffic or the number of terminals with respect to each base station apparatus. Fixed allocation resource calculation unit of a resource allocation calculation apparatus 3 performs resource allocation calculations. Dynamic allocation resource calculation unit receives the information on traffic or the number of terminals detected by the load detection apparatus to perform the resource allocation suitable for load distribution. A resource allocation control apparatus sets resources into each base station apparatus based on the information on resource allocation.

### BACKGROUND OF THE INVENTION

1. Field of the Invention

The present invention relates to radio access communications networks, dynamic load distribution apparatuses and dynamic load distribution methods used in the same, and more particularly to a load distribution method for arranging base stations which constitute a radio access communications network.

2. Description of Related Art

Heretofore, a principal object of designing a wireless LAN (Local Area Network) access method has been to arrange base stations (access points) so as to cover an area without causing frequency interference.

However, as the object of designing a wireless LAN access method, in addition to securing connections, there is a growing demand for service quality including throughput. In the future, it is expected that the unit price of base station hardware will be reduced, and that the number of base stations capable of transmitting/receiving at multiple frequencies at the same time will increase. This also constitutes a factor of facilitating improvement of service quality.

Consequently, it is not hardware but finite effective resources, such as frequency, that become a limiting factor. Thus, it is important to adapt dynamically to loads, such as traffic and the number of terminals, to allocate flexibly resources.

The conventional radio access communication described above has multiple objects including coverage of all requesting areas in order to establish communication, load distribution by allocating resources, such as frequency, to areas with large load, and minimizing of the number of resource-switching times. When, in order to achieve these multiple objects, a dynamic control is performed according to the change of load which changes with time periodically or non-periodically, an inefficient allocation or complex algorism may result.

In the technique disclosed in the Japanese Patent Application Laid-Open No. HEI 10-66138, it is supposed that the cost of base stations is high in the conventional radio network systems; thus, a control by a mobile base station is employed to deal with the occurrence of trouble or with excessive traffic at a single location or a small number of locations. With this technique, when a congested area shifts frequently, it takes time for the mobile base station to replace to suitable new location. Also, each base station has a limited role; there are base stations for covering one area and ones for reducing congestion, thus restricting frequency allocation.

In the technique disclosed in the Japanese Patent Application Laid-Open No. 2002-262344, there is made a distinction between base stations for covering the entire area and ones used for load distribution depending on the size of an area secured by a base station, thus restricting frequency allocation.

### SUMMARY OF THE INVENTION

To solve the above problem, an object of the present invention is to provide a radio access communications network and dynamic load distribution apparatus in which resource allocation calculation for load distribution can employ a simple and dynamically flexible algorism, and a dynamic load distribution method used in the same.

According to the present invention, there is provided a radio access communications network including a plurality of base stations and a resource allocation calculation apparatus which performs allocation calculation for the purpose of controlling resources including at least frequency with respect to the plurality of base stations, wherein: the resource allocation calculation apparatus includes fixed allocation resource calculation means for calculating fixed allocation resources for the purpose of securing connections in the entire area managed by the plurality of base stations, and dynamic allocation resource calculation means for calculating dynamic allocation resources which are allocated to the plurality of base stations for the purpose of distributing load; and the resources are allocated with frequencies which each of the fixed allocation resource calculation means and dynamic allocation resource calculation means handles.

According to the present invention, there is provided a dynamic load distribution apparatus which performs dynamic load distribution based on the calculation result of a resource allocation calculation apparatus which performs allocation calculation for the purpose of controlling resources including at least frequency with respect to a plurality of base stations, wherein: the resource allocation calculation apparatus includes fixed allocation resource calculation means for calculating fixed allocation resources for the purpose of securing connections in the entire area managed by the plurality of base stations, and dynamic allocation resource calculation means for calculating dynamic allocation resources which are allocated to the plurality of base stations for the purpose of distributing load; and the resources are allocated with frequencies which each of the fixed allocation resource calculation means and dynamic allocation resource calculation means handles.

According to the present invention, there is provided a dynamic load distribution method in a radio access communications network which includes a plurality of base stations and a resource allocation calculation apparatus which performs allocation calculation for the purpose of controlling resources including at least frequency with respect to the plurality of base stations, wherein: the resource allocation calculation apparatus side includes a first step of calculating fixed allocation resources for the purpose of securing connections in the entire area managed by the plurality of base stations, and a second step of calculating dynamic allocation resources which are allocated to the plurality of base stations for the purpose of distributing load; and the resources are allocated with frequencies which each of the first and second steps handles.

Specifically, with the radio access communications network according to the present invention, there is provided a method in which a division of roles is not made between the base stations from the beginning, but the allocation of resources such as frequency is layered in such a way that the resources are allocated fixedly or for the purpose of load distribution, and is optimized uniquely in the algorisms of each layer.

With the radio access communications network according to the present invention, the resources such as frequency are divided so that there is made a distinction between the resources for covering the entire area and those for distributing load. Also, with the radio access communications network according to the present invention, the optimization of these two objects are performed not at the same time, but each object is optimized with the divided resources, and a number N of resources (to be used as reserve resources), which are not included in any of the divided resources, are kept to be held, thereby allowing coping with Nth-degree troubles.

With the radio access communications network according to the present invention, in order to cover the entire area with finite radio resources such as frequency in a radio access communications network in which multiple areas (coverage area of one base station) are adjacent to each other, or overlap with each other, there is made a distinction between finite resources to be used fixedly (referred to as a fixed allocation resource) and finite resources to be used for load distribution (referred to as a dynamic allocation resource), and as a load distribution control method, there is employed one which makes only the dynamic allocation resources variable, whereby it is possible to provide a simple algorism which can flexibly cope with changes. Herein, a dynamic allocation resource denotes radio frequency, time slot in time-division multiplex communication, and code in code-division multiplex communication; all resources which cause interferences with respect to adjacent areas as well as overlapping areas are included in this category.

More specifically, with the radio access communications network according to the present invention, a resource allocation calculation for the purpose of the radio system covering the entire area is performed by use of the information on terminal location acquired from an input apparatus or from a location information automatic-detection apparatus by the fixed allocation resource calculation means. The dynamic allocation resource calculation means receives the information on traffic or the number of terminals detected by a load detection apparatus, or the information on trouble detected by a trouble detection apparatus to perform the resource allocation suitable for load distribution.

With the radio access communications network according to the present invention, the information on load is collected by the load detection apparatus. Specifically, the number of terminals, the traffic or the like is collected based on statistical information, or on the count result obtained in a room or at the building entrance, or on the image analysis using monitoring devices with motion capture, or on the number of on/off times of electrical power supplied to lighting, etc.

In this way, with the radio access communications network according to the present invention, after all the resources are divided into those for covering the entire area and those for distributing load, the resource allocation calculation is performed. Thus, the resource allocation calculation for distributing load can be implemented by a simple and dynamically flexible algorism.

By employing a configuration and operation to be described below, there is achieved the beneficial effect of the present invention such that the resource allocation calculation for distributing load can be implemented by a simple and dynamically flexible algorism.

### BRIEF DESCRIPTION OF THE DRAWINGS

The objects and features of the present invention will become more apparent from the consideration of the following detailed description taken in conjunction with the accompanying drawings, in which:

FIG. 1 is a block diagram showing a configuration of a dynamic load distribution apparatus used in a radio access communications network according to one embodiment of the present invention;

FIG. 2 is a flowchart showing a processing operation of resource allocation calculation according to one embodiment of the present invention;

FIG. 3 is a flowchart showing a processing operation of dynamic resource allocation calculation of FIG. 2;

FIG. 4 is a diagram showing the coverage area of a base station apparatus according to one embodiment of the present invention;

FIG. 5 is a diagram showing the coverage area of a base station apparatus according to one embodiment of the present invention;

FIG. 6 is a diagram showing the coverage area of a base station apparatus according to one embodiment of the present invention;

FIG. 7 is a block diagram showing a configuration of a dynamic load distribution apparatus used in a radio access communications network according to another embodiment of the present invention;

FIG. 8 is a flowchart showing a processing operation of resource allocation calculation according to another embodiment of the present invention; and

FIG. 9 is a block diagram showing a configuration of a dynamic load distribution apparatus used in a radio access communications network according to a different embodiment of the present invention.

### DESCRIPTION OF THE PREFERRED EMBODIMENTS

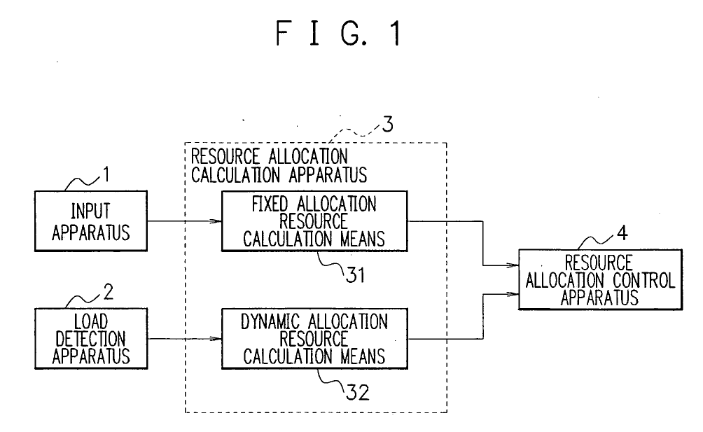

An embodiment of the present invention will now be described with reference to the accompanying drawings. FIG. 1 is a block diagram showing a configuration of a dynamic load distribution apparatus used in a radio access communications network according to one embodiment of the present invention. Referring to FIG. 1, a dynamic load distribution apparatus according to one embodiment of the present invention includes an input apparatus 1, load detection apparatus 2, resource allocation calculation apparatus 3 and resource allocation control apparatus 4; the resource allocation calculation apparatus 3 includes fixed allocation resource calculation means 31 and dynamic allocation resource calculation means 32.

The input apparatus 1 receives from the network administrator the information on location of each base station apparatus (not shown) or the information (usable resource) on base station apparatus to supply the data to the fixed allocation resource calculation means 31 of the resource allocation calculation apparatus 3 or dynamic allocation resource calculation means 32.

The load detection apparatus 2 acquires the traffic or the number of terminals with respect to each base station apparatus to supply the data to the dynamic allocation resource calculation means 32. The resource allocation calculation apparatus 3 performs resource allocation calculation by use of the information on terminal location supplied from the input apparatus 1 and the information on load supplied from the load detection apparatus 2. The load detection apparatus 2 collects the number of terminals, the traffic or the like based on statistical information, or on the count result obtained in a room or at the building entrance, or on the image analysis using monitoring devices with motion capture, or on the number of on/off times of electrical power supplied to lighting, etc.

In the resource allocation calculation apparatus 3, the fixed allocation resource calculation means 31 performs the resource allocation calculation for the purpose of the radio system covering the entire area by use of the information on terminal location supplied from the input apparatus 1. The dynamic allocation resource calculation means 32 receives the information on traffic or the number of terminals detected by the load detection apparatus 2 to perform the resource allocation suitable for load distribution.

The resource allocation control apparatus 4 receives the information on resource allocation from the fixed allocation resource calculation means 31 or dynamic allocation resource calculation means 32 to set resources allocated for each terminal or for each session of each terminal into each base station apparatus.

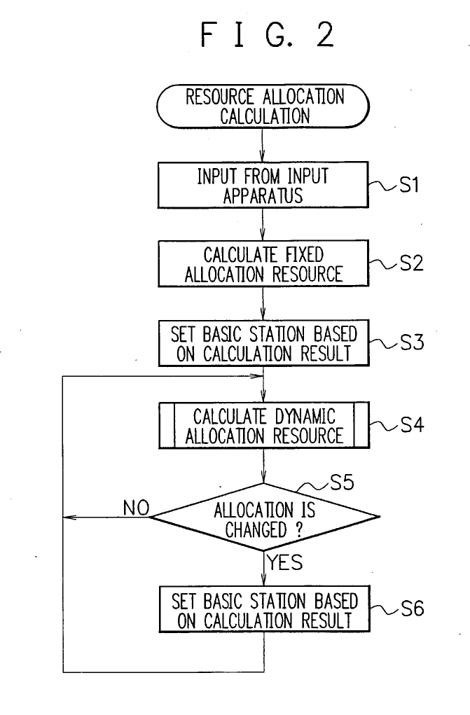

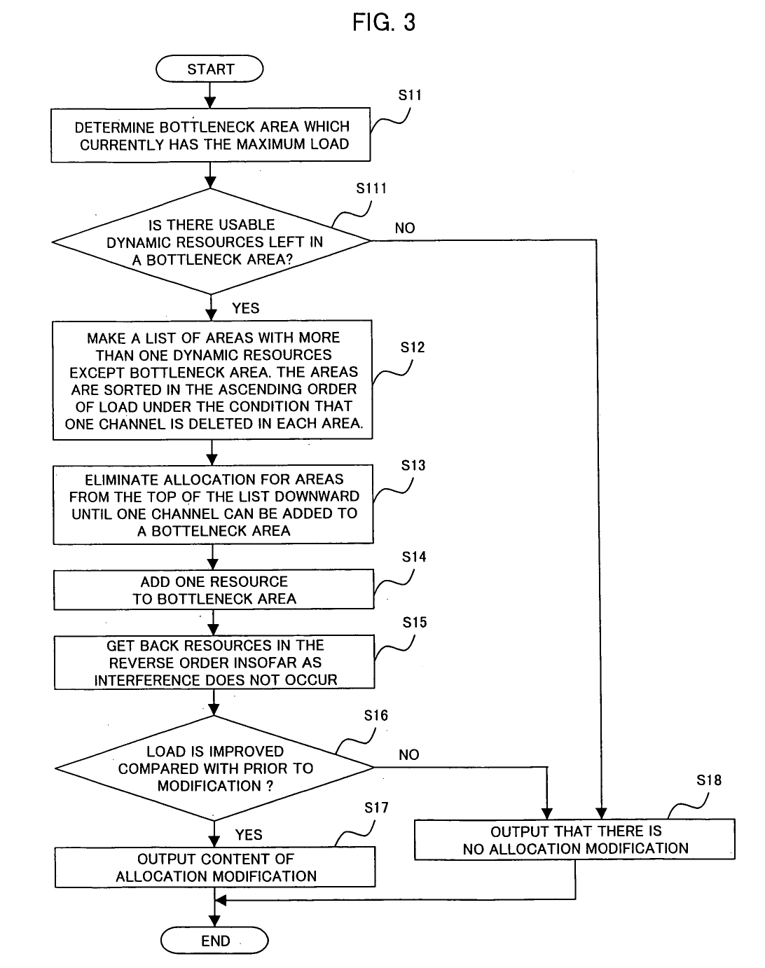

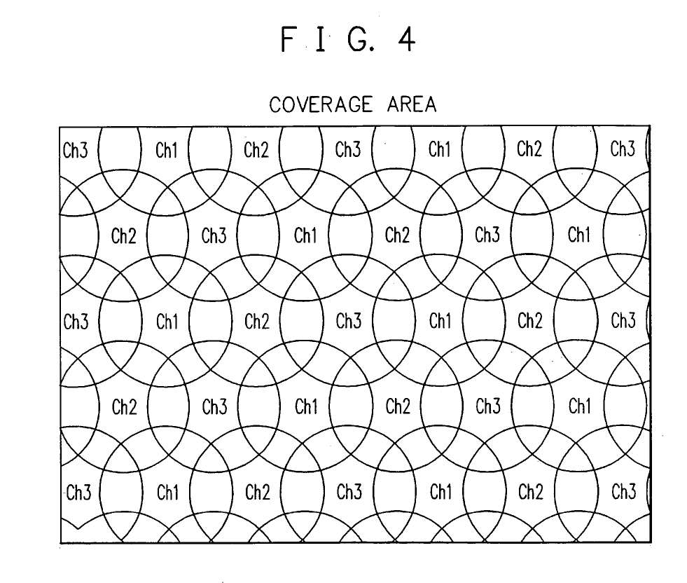

FIG. 2 is a flowchart showing a processing operation of resource allocation calculation according to one embodiment of the present invention. FIG. 3 is a flowchart showing a processing operation of dynamic resource allocation calculation of FIG. 2. FIGS. 4 to 6 are a diagram showing the coverage area of a base station apparatus according to one embodiment of the present invention. An operation of a radio access communications network according to one embodiment of the present invention will be described with reference to FIGS. 1 to 6. In FIGS. 4 to 6, a circle indicates the coverage area of a base station apparatus positioned at the center of the circle.

In the embodiment, firstly suppose that frequency is set as a finite resource, and that there exist six frequencies which do not interfere with each other even when used in adjacent areas. Each base station apparatus can select any number of any frequencies from among the six frequencies. The frequency bands are referred to as Ch1 (channel 1), Ch2, Ch3, Ch4, Ch5 and Ch6, respectively. Also, in the embodiment, suppose that a given area is covered with at least one frequency (M=1) to deal with the primary trouble (N=1).

Firstly, the user inputs the information on location of base station apparatuses via the input apparatus 1 (step S1 of FIG. 2). Based on the information on location, the resource allocation calculation apparatus 3 performs the allocation calculation for covering the entire area with at least one frequency (M=1) by use of the fixed allocation resource calculation means 31 (step S2 of FIG. 2). Herein, as shown in FIG. 4, suppose that the entire area can be covered with three frequencies Ch1, Ch2 and Ch3.

The resource allocation control apparatus 4 receives the information on resource allocation from the fixed allocation resource calculation means 31 to set resources allocated for each terminal or for each session of each terminal into each base station apparatus (step S3 of FIG. 2).

Subsequently, the resource allocation calculation apparatus 3 calculates resource allocation by use of the dynamic allocation resource calculation means 32 (step S4 of FIG. 2). The details of the processing of the dynamic resource allocation calculation of step S4 are shown in FIG. 3.

From among the entire area, the dynamic allocation resource calculation means 32 determines a base station apparatus which has the maximum load per allocated frequency, and designates the determined area as a bottleneck area (step S11 of FIG. 3). When there are still usable dynamic resources left and it is confirmed that the dynamic resources can be added (step S111/YES of FIG. 3), the dynamic allocation resource calculation means 32 generates a list where sorted are areas to which more than one dynamic resources have already been allocated, excluding bottleneck areas. The list is made in a manner that supposing one channel for a dynamic resource in each area is deleted, areas line in the ascending order of load per channel (step S12 of FIG. 3). Since there is no dynamic allocation in the entire area at the initial condition, this step is skipped. Thus, the list remains empty. In the case where there are not available dynamic resources left for a bottleneck area at step S111 (step S111/NO), the process goes to step S18 and it is outputted that there is no allocation modification.

Then the dynamic allocation resource calculation means 32 deletes, starting from the beginning of the list, allocation for channels of the areas that were lined up in the ascending order of load at step S12 under the condition that one channel is deleted. This process continues until there exist channels available to allocate for both a bottleneck area and adjacent areas that share part of the area with the bottleneck area (step S13 of FIG. 3). When among channels deleted from other areas channels allocatable for bottleneck areas become available for the bottleneck areas and the adjacent areas, each usable channel is added to the bottleneck areas (step S14 of FIG. 3). With the list empty in the initial state, resources can be allocated to a bottleneck area and adjacent areas that share part of the area with the bottleneck area even when frequencies to be allocated to those areas are not reused from other areas. Thus, the dynamic allocation resource calculation means 32 performs no processing at step S13, and adds one channel each to a bottleneck area and adjacent areas that share part of the area with the bottleneck area at step S14.

The dynamic allocation resource calculation means 32 lets the resources, which were deleted from each area under the process so far, go back to channels of areas in the descending order of load the areas possess. (step S15 of FIG. 3). The existence of mutual interference is checked and insofar as the mutual interference does not occur, deleted resources are brought back. In this process, dynamic resources being used in another area are deleted and then added to a bottleneck area, but resources might be unnecessarily deleted. Therefore, this process intends to get back a state prior to the deleting process as nearly as possible, confirming that no problem arises even if the unnecessarily deleted resources are brought back. Since no particular process is need for the initial state, this process is skipped and the process at step S16 starts.

The dynamic allocation resource calculation means 32 confirms that the maximum load per allocated frequency is reduced by the above modification (step S16 of FIG. 3), and outputs the contents of the modification (step S17 of FIG. 3). In this way, an allocated frequency is added to one area by the process of step S4.

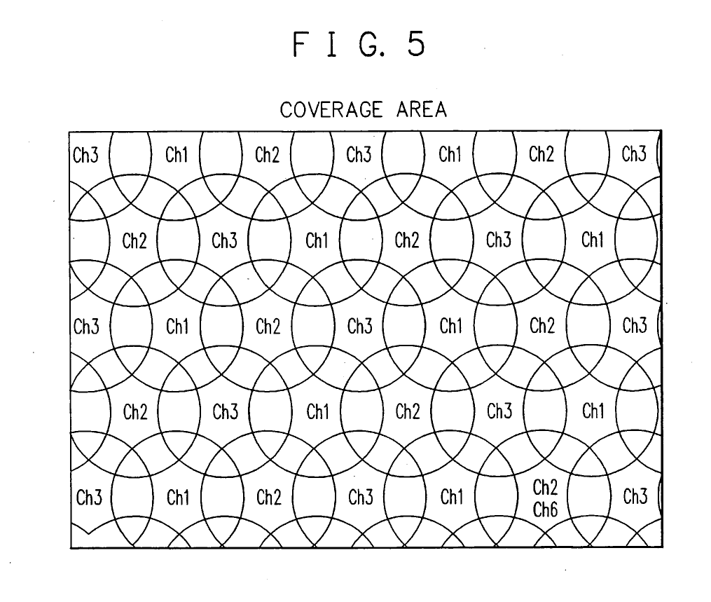

The resource allocation control apparatus 4 receives the information on resource allocation from the dynamic allocation resource calculation means 32 to set resources allocated for each terminal or for each session of each terminal into each base station apparatus (steps S5 and S6 of FIG. 2). FIG. 5 shows a case where, with the load large in the lower right section, a base station of an area using Ch2 also uses Ch6.

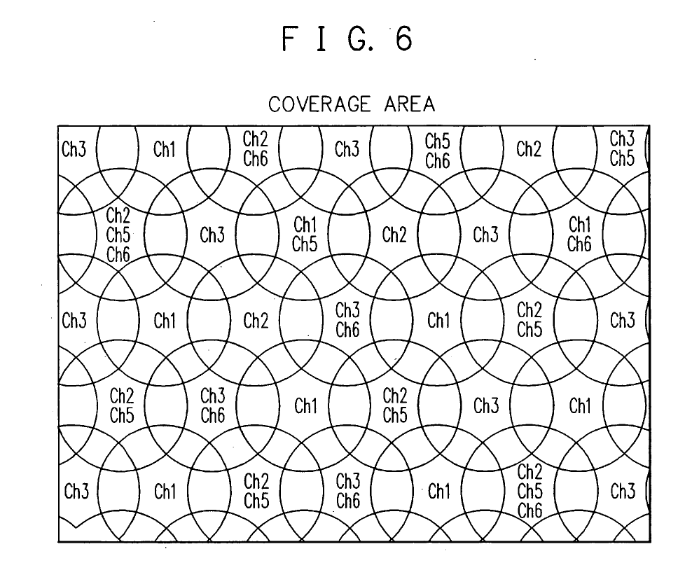

Subsequently, the resource allocation calculation apparatus 3 returns to the process of step S4, and repeats the processes of steps S4 to S6. In this way, with the embodiment, the addition of allocated frequency is repeated. A state of allocation in which there is no margin of further resources for dynamic allocation is shown in FIG. 6. With the embodiment, as described above, the resource allocation calculation adapted for the renewed increase/decrease of load is performed.

As described above, with the embodiment, resources for covering an area and those for distributing load are separated prior to allocation. Thus, the resource allocation calculation for distributing load can be implemented by a simple and dynamically flexible algorism.

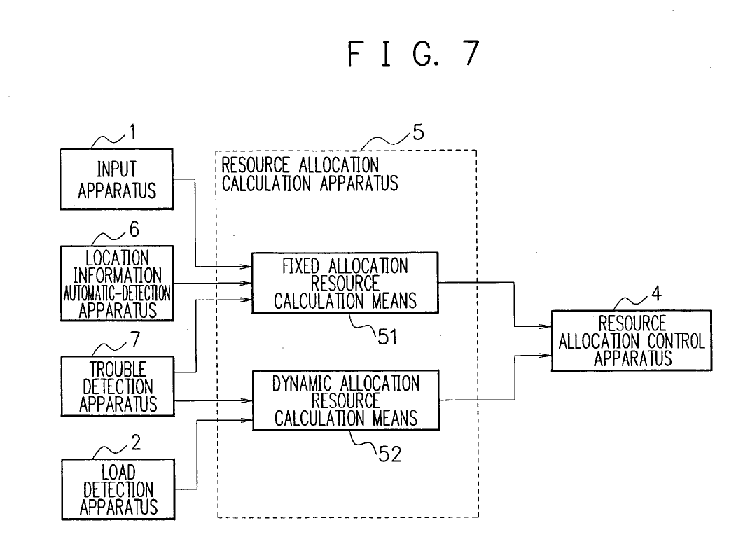

FIG. 7 is a block diagram showing a configuration of a dynamic load distribution apparatus used in a radio access communications network according to another embodiment of the present invention. Referring to FIG. 7, the dynamic load distribution apparatus according to another embodiment of the present invention has a configuration similar to that of the dynamic load distribution apparatus according to one embodiment of the present invention shown in FIG. 1 except that a location information automatic-detection apparatus 6 and a trouble detection apparatus 7 are added, whereby the resource allocation calculation apparatus 5 performs resource allocation calculation by adding the detection result of each of the location information automatic-detection apparatus 6 and the trouble detection apparatus 7. Thus, the same reference numerals are applied to corresponding constituent elements. The operations of the corresponding constituent elements are similar to those of one embodiment according to the present invention.

The input apparatus 1 receives from the network administrator the information on location of each base station apparatus and the information (usable resource) on base station apparatus, and supplies the data to a fixed allocation resource calculation means 51 or dynamic allocation resource calculation means 52.

The location information automatic-detection apparatus 6 receives the information on location of each base station apparatus obtained by a sensing operation, and supplies the data to the fixed allocation resource calculation means 51 or the dynamic allocation resource calculation means 52. The trouble detection apparatus 7 detects the trouble of each base station apparatus to supply the data to the fixed allocation resource calculation means 51 or dynamic allocation resource calculation means 52. The load detection apparatus 2 detects the traffic or the number of terminals with respect to each base station apparatus to supply the data to the dynamic allocation resource calculation means 52.

The resource allocation calculation apparatus 5, which includes the fixed allocation resource calculation means 51 and the dynamic allocation resource calculation means 52, performs the resource allocation calculation by use of the information on terminal location received from the input apparatus 1, the information on terminal location received from the location information automatic-detection apparatus 6, the information on trouble detected by the trouble detection apparatus 7, and the information on load received from the load detection apparatus 2.

The fixed allocation resource calculation means 51 performs the resource allocation calculation for the purpose of the radio system covering the entire area by use of the information on terminal location received from the input apparatus 1 or the information on terminal location obtained from the location information automatic-detection apparatus 6. The dynamic allocation resource calculation means 52 receives the information on traffic or the number of terminals detected by the load detection apparatus 2, or the information on trouble detected by the trouble detection apparatus 7 to perform the resource allocation suitable for load distribution.

The resource allocation control apparatus 4 receives the information on resource allocation from the fixed allocation resource calculation means 51 or the dynamic allocation resource calculation means 52 to set resources allocated for each terminal or for each session of each terminal into each base station apparatus.

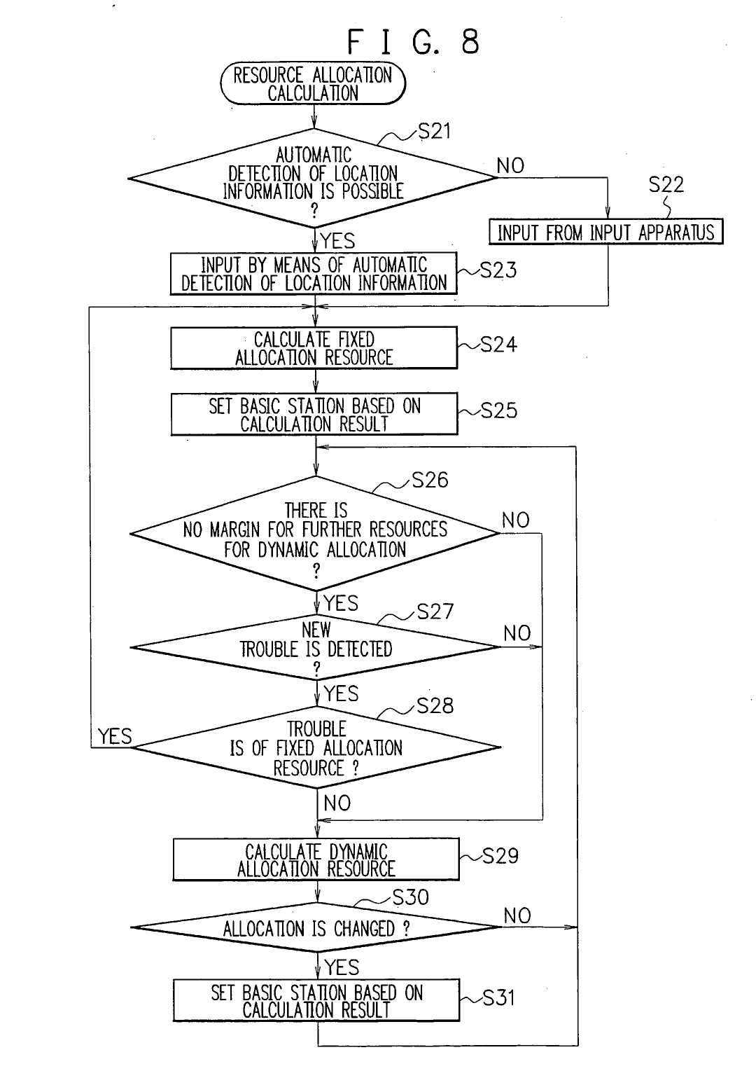

FIG. 8 is a flowchart showing a processing operation of resource allocation calculation according to another embodiment of the present invention. In the resource allocation calculation according to another embodiment of the present invention, the processing operation of dynamic resource allocation calculation is similar to that of one embodiment according to the present invention shown in FIG. 3. The coverage area of base station apparatus is also similar to that of one embodiment according to the present invention shown in FIGS. 4 to 6. An operation of a radio access communications network according to another embodiment of the present invention will be described with reference to FIGS. 3 to 8.

In the embodiment, firstly suppose that frequency is set as a finite resource, and that there exist six frequencies which do not interfere with each other even when used in adjacent areas. Each base station apparatus can select any numbers of any frequencies from among the six frequencies. The frequency bands are referred to as Ch1 (channel 1), Ch2, Ch3, Ch4, Ch5 and Ch6, respectively. Also, in the embodiment, suppose that a given area is covered with at least one frequency (M=1) to deal with the primary trouble (N=1).

In the radio system according to the present embodiment, firstly the resource allocation calculation apparatus 5 determines whether or not the information on location of each base station apparatus can be automatically detected (step S21 of FIG. 8). In the present embodiment, assuming that the information on location of each base station apparatus can be automatically detected, the information on location is detected by the location information automatic-detection apparatus 6 and sent to the fixed allocation resource calculation means 51 (step S23 of FIG. 8).

The fixed allocation resource calculation means 51 performs the allocation calculation for covering the entire area with at least one frequency (M=1) by use of the information on allocation (step S24 of FIG. 8). Herein, as shown in FIG. 4, suppose that the entire area can be covered with three frequencies Ch1, Ch2 and Ch3. In FIG. 4, a circle indicates the coverage area of a base station apparatus positioned at the center of the circle. The resource allocation control apparatus 4 sets the calculation result into each base station apparatus (step S25 of FIG. 8).

The resource allocation calculation apparatus 5 determines that two unused channels (Ch5 and Ch6), except the three channels used for covering the entire area and the channel (Ch4) for dealing with a problem (N=1), still have an extra capacity for accommodation (step S26 of FIG. 8). Thus, the dynamic allocation resource calculation means 52 performs the resource allocation calculation (step S29 of FIG. 8). The details of the process of step S29 are shown in FIG. 3 like those of one embodiment according to the present invention.

From among the entire area, the dynamic allocation resource calculation means 52 determines a base station apparatus which has the maximum load per allocated frequency, and sets the determined area as a bottleneck area (step S11 of FIG. 3). Since there is no dynamic allocation in the entire area, there exists no area in which a frequency can be eliminated. Thus, the dynamic allocation resource calculation means 52 determines that the list is empty (step S12 of FIG. 3).

With the list empty, a resource can be allocated to the bottleneck area even when an allocated frequency is not eliminated. Thus, the dynamic allocation resource calculation means 52 performs no process, and proceeds to step S14 (step S13 of FIG. 3). Then, the dynamic allocation resource calculation means 52 adds one resource to the bottleneck area (step S14 of FIG. 3).

Since no allocated frequency is eliminated, the dynamic allocation resource calculation means 52 performs no processing, and proceeds to step S16 (step S15 of FIG. 3). The dynamic allocation resource calculation means 52 confirms that the maximum load per allocated frequency is reduced by the above modification (step S16 of FIG. 3), and outputs the contents of the modification (step S17 of FIG. 3).

In this way, with the present embodiment, an allocated frequency is added to one area by the process of step S29. The resource allocation control apparatus 4 sets each base station apparatus based on the calculation result (steps S30 and S31 of FIG. 8). FIG. 5 shows a case where, with the load large in the lower right section, a base station of an area using Ch2 also uses Ch6.

Subsequently, the resource allocation calculation apparatus 5 returns to the process of step S26, and repeats the processes of steps S26, S27 and S29 to S31 until there is no margin for further resources for dynamic allocation and a trouble is found out in step S27. Also, with the present embodiment, even when there is no margin of dynamic resource, the processes of steps S26, S27 and S29 to S31 are repeated until a trouble is found out in step S27. With the present embodiment, when the addition of frequency allocation is repeated in this way, there occurs a state of allocation in which there is no margin of further resources for dynamic allocation. This state is shown in FIG. 6.

With the present embodiment, when a new trouble is found out in step S27, it is determined whether the trouble concerns about the fixed allocation resource or the dynamic allocation resource (step S28 of FIG. 8). When the trouble detection apparatus 7 detects a trouble of Ch3 in an area using Ch3 positioned in the upper left section of FIG. 6, the resource allocation calculation apparatus 5 proceeds to step S24 because the trouble has taken place among the fixed allocation resources. In the fixed resource allocation calculation performed when trouble occurs, the use of the extra channel (Ch4) reserved for trouble is permitted. Thus, the calculation is performed by use of Ch4.

In this way, with the present embodiment, the resource allocation calculation adapted for the renewed increase/decrease of load or occurrence of trouble can be performed.

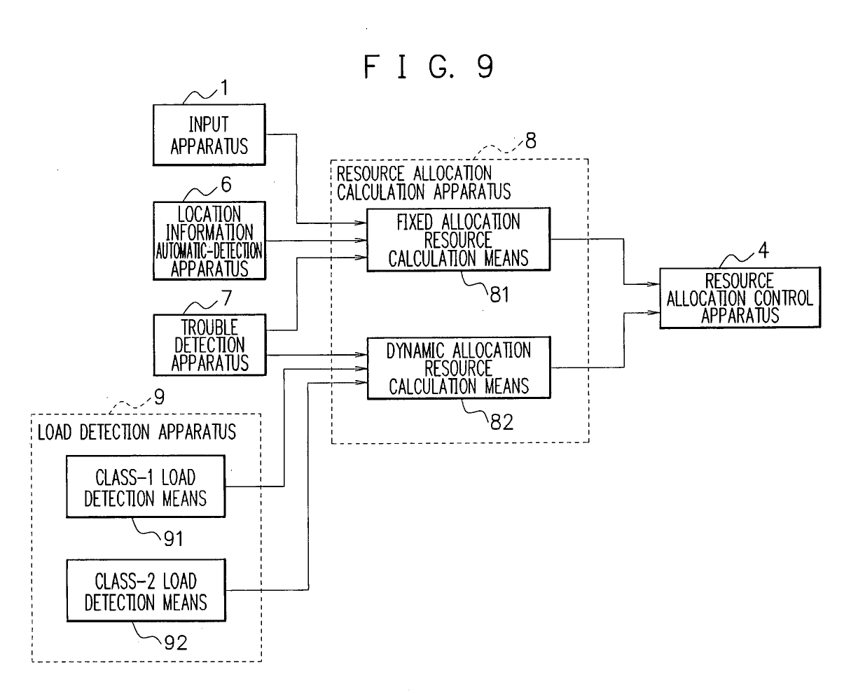

FIG. 9 is a block diagram showing a configuration of a dynamic load distribution apparatus used in a radio access communications network according to a different embodiment of the present invention. Referring to FIG. 9, the dynamic load distribution apparatus according to the different embodiment of the present invention has a configuration similar to that of the dynamic load distribution apparatus according to another embodiment of the present invention shown in FIG. 7 except that the load detection apparatus 9 includes a class-1 load detection means 91 and a class-2 load detection means 92. Thus, the same reference numerals are applied to corresponding constituent elements. The operations of the corresponding constituent elements are similar to those of another embodiment according to the present invention.

The load detection apparatus 9, which includes the class-1 load detection means 91 and the class-2 load detection means 92, detects the traffic or the number of terminals for each class with respect to each base station apparatus, and supplies the data to the dynamic allocation resource calculation means 82. Herein, the term “class” serves to classify objects which are different from each other in terms of features such as required service quality of voice, data, etc. and protocol.

The class-1 load detection means 91 detects the load of traffic preliminarily defined as class 1 to supply the data to the dynamic allocation resource calculation means 82. The class-2 load detection means 92 detects the load of traffic preliminarily defined as class 2 to supply the data to the dynamic allocation resource calculation means 82.

The above class 1 corresponds to the traffic which has a severe requirement for delay quality, such as in voice communication. The above class 2 corresponds to the traffic which does not have a severe requirement for delay quality, such as in data communications.

With the present embodiment, the dynamic allocation resource calculation means 82 performs the resource allocation based on the number of terminals or the transmitting/receiving traffic for each base station without distinguishing between the classes, and class 1 is accommodated in the fixed allocation resources. When plural resources including fixed allocation resources and dynamic allocation resources are allocated to a given area, class 2 is allocated in a restricted manner so that the load of the resources in which class 1 is accommodated is not increased. Specifically, there is employed a restriction such that class 2 is accommodated only in resources different from class-1 resources, or a slightly looser restriction such that class 2 is accommodated preferentially to the different resources.

What has been described herein is merely illustrative of the application of the principles of the present invention. Other arrangements and methods may be implemented by those skilled in the art without departing from the scope and spirit of the invention.

1. A radio access communications network comprising a plurality of base stations and a resource allocation calculation apparatus which performs allocation calculation for the purpose of controlling resources including at least frequency with respect to the plurality of base stations, wherein:
the resource allocation calculation apparatus includes fixed allocation resource calculation means for calculating fixed allocation resources for the purpose of securing connections in the entire area managed by the plurality of base stations, and dynamic allocation resource calculation means for calculating dynamic allocation resources which are allocated to the plurality of base stations for the purpose of distributing load; and
the resources are allocated with frequencies which each of the fixed allocation resource calculation means and dynamic allocation resource calculation means handles.

2. The radio access communications network according to claim 1, further comprising detection means for detecting the information on location of each of the plurality of base stations and detection means for detecting a trouble of each of the plurality of base stations, wherein the detection result on the information on location and on the trouble is reflected in the allocation calculation performed by the resource allocation calculation apparatus.

3. The radio access communications network according to claim 1, wherein statistics on the information on load are produced for the purpose of distributing load for each class selected with reference to at least required service quality and protocol, and the result is reflected in the calculation performed by the dynamic allocation resource calculation means.

4. A dynamic load distribution apparatus which performs dynamic load distribution based on the calculation result of a resource allocation calculation apparatus which performs allocation calculation for the purpose of controlling resources including at least frequency with respect to a plurality of base stations, wherein:
the resource allocation calculation apparatus includes fixed allocation resource calculation means for calculating fixed allocation resources for the purpose of securing connections in the entire area managed by the plurality of base stations, and dynamic allocation resource calculation means for calculating dynamic allocation resources which are allocated to the plurality of base stations for the purpose of distributing load; and
the resources are allocated with frequencies which each of the fixed allocation resource calculation means and dynamic allocation resource calculation means handles.

5. The dynamic load distribution apparatus according to claim 4, further comprising detection means for detecting the information on location of each of the plurality of base stations and detection means for detecting a trouble of each of the plurality of base stations, wherein the detection result on the information on location and on the trouble is reflected in the allocation calculation performed by the resource allocation calculation apparatus.

6. The dynamic load distribution apparatus according to claim 4, wherein statistics on the information on load are produced for the purpose of distributing load for each class selected with reference to at least required service quality and protocol, and the result is reflected in the calculation performed by the dynamic allocation resource calculation means.

7. A dynamic load distribution method in a radio access communications network which includes a plurality of base stations and a resource allocation calculation apparatus which performs allocation calculation for the purpose of controlling resources including at least frequency with respect to the plurality of base stations, wherein:
the resource allocation calculation apparatus side includes a first step of calculating fixed allocation resources for the purpose of securing connections in the entire area managed by the plurality of base stations, and a second step of calculating dynamic allocation resources which are allocated to the plurality of base stations for the purpose of distributing load; and
the resources are allocated with frequencies which each of the first and second steps handles.

8. The dynamic load distribution method according to claim 7, wherein:
the resource allocation calculation apparatus side includes a step of detecting the information on location of each of the plurality of base stations and a step of detecting a trouble of each of the plurality of base stations; and
the detection result on the information on location and on the trouble is reflected in the allocation calculation performed by the resource allocation calculation apparatus.

9. The dynamic load distribution method according to claim 7, wherein statistics on the information on load are produced for the purpose of distributing load for each class selected with reference to at least required service quality and protocol, and the result is reflected in the dynamic allocation resource calculation.

10. The radio access communications network according to claim 2, wherein statistics on the information on load are produced for the purpose of distributing load for each class selected with reference to at least required service quality and protocol, and the result is reflected in the calculation performed by the dynamic allocation resource calculation means.

11. The dynamic load distribution apparatus according to claim 5, wherein statistics on the information on load are produced for the purpose of distributing load for each class selected with reference to at least required service quality and protocol, and the result is reflected in the calculation performed by the dynamic allocation resource calculation means.

12. The dynamic load distribution method according to claim 8, wherein statistics on the information on load are produced for the purpose of distributing load for each class selected with reference to at least required service quality and protocol, and the result is reflected in the dynamic allocation resource calculation.
